(19) United States
(12) Patent Application Publication
(10) Pub. No.: US 2009/0327213 A1
(43) Pub. Date: Dec. 31, 2009

(54) DOCUMENT INDEX FOR HANDHELD APPLICATION NAVIGATION

(75) Inventor: Bibhu Choudhary, Hyderabad (IN)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/146,130

(22) Filed: Jun. 25, 2008

(51) Int. Cl. G06F 17/30

(52) U.S. Cl. 707/2; 707/E17.002

(57) ABSTRACT

A mobile device includes an application programmed to include an input/output module programmed to load a document and render the document on the display. The application also includes a parsing module programmed to parse the document and to identify certain tags within the document that are associated with data structures. The application further includes an index generation module programmed to create a document index based on the certain tags identified by the parsing module, the document index being formed in a hierarchy.

### BACKGROUND

Handheld devices, such as personal digital assistants (PDAs) or smartphones, are portable, lightweight electronic computing devices. Such handheld devices provide a user with a wide variety of functional capabilities relating to communications and/or software applications.

A handheld device user's quality of experience is frequently limited, however, as a consequence of the reduced screen size, as compared to the screen size of a standard personal computer (PC). The reduced screen size of the handheld device may not be conducive to viewing a document authored in a software application optimized for PC viewing. Further, it can be difficult to navigate through a complex document on a handheld device while searching for specific content.

### SUMMARY

Embodiments of the present disclosure generally relate to systems and methods for generating a document index for handheld application navigation.

According to one aspect, a mobile device includes a display, and a computer readable storage medium storing a document file. The device also includes an application stored on the computer readable storage medium, the application being programmed to include: an input/output module programmed to load a document and render the document on the display; a parsing module programmed to parse the document and to identify certain tags within the document that are associated with data structures; and an index generation module programmed to create a document index based on the certain tags identified by the parsing module, the document index being formed in a hierarchy.

According to another aspect, a mobile device includes a display, and a computer readable storage medium storing a spreadsheet document. The device also includes a spreadsheet application stored on the computer readable storage medium, the spreadsheet application being programmed to include: an input/output module programmed to load the spreadsheet document and render the spreadsheet document on the display, the spreadsheet document being stored in an extensible markup language format; a parsing module programmed to parse the spreadsheet document and to identify certain extensible markup language tags within the document that are associated with data structures of the spreadsheet document, the data structures including a workbook name, a spreadsheet name, and a chart name; and an index generation module programmed to create a document index based on the certain extensible markup language tags identified by the parsing module corresponding to the data structures, the document index being formed in a tree-like hierarchy including a plurality of entries, each of the entries including a summary of one of the data structures and being linked to the data structure. The document index is automatically generated when the spreadsheet document is opened, and, when a user selects a specific entry in the document index, the spreadsheet application is further programmed to display a data structure of the spreadsheet document associated with the specific entry on the display.

According to yet another aspect, a method for creating a document index includes: opening a spreadsheet document; parsing the spreadsheet document to identify tags associated with specific data structures of the spreadsheet document; identifying certain extensible markup language tags identified during parsing, the tags corresponding to the data structures; and creating the document index based on the identified tags, the document index being formed in a tree-like hierarchy including a plurality of entries, each of the entries including a summary of one of the data structures and being linked to the data structure.

This Summary is provided to introduce a selection of concepts in a simplified form that are further described below in the Detailed Description. This Summary is not intended to identify key or essential features of the claimed subject matter, nor is it intended to be used in any way as to limit the scope of the claimed subject matter.

### BRIEF DESCRIPTION OF THE DRAWINGS

FIG. 1 shows a system including a client and a server.

FIG. 2 shows an example mobile device.

FIG. 3 shows additional details of the mobile device of FIG. 2.

FIG. 4 shows an example spreadsheet application of the mobile device of FIG. 3.

FIG. 5 shows an example spreadsheet workbook on a personal computer.

FIG. 6 shows the spreadsheet workbook of FIG. 5 on a mobile device.

FIG. 7 shows another example mobile device including a document index.

FIG. 8 shows another view of the mobile device and document index of FIG. 7.

FIG. 9 shows a spreadsheet document that is displayed on the mobile device dafter selection of a portion of the document index shown in FIG. 8.

FIG. 10 shows an example method for generating a document index.

### DETAILED DESCRIPTION

This disclosure will now more fully describe exemplary embodiments with reference to the accompanying drawings, in which specific embodiments are shown. Other aspects may, however, be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

The present application is directed to systems and methods for generating a document index of a document on a mobile device such that the mobile device user can easily navigate through the document to select desired contents. The techniques used to generate and present the document index to the user on the mobile device can be applicable to any situation where simplified navigation through a document or a data set is desired.

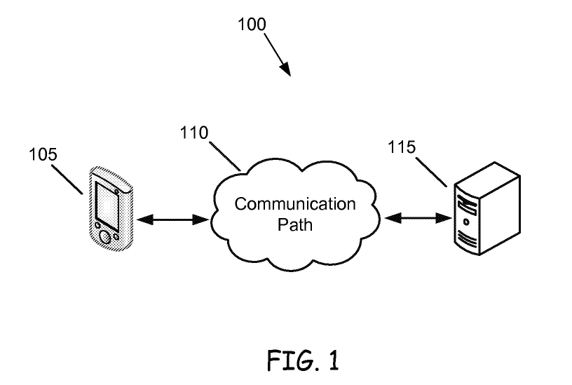

FIG. 1 shows an example network 100 for operating a mobile device. In one aspect, the example network 100 includes a client computing system 105, a communication medium 110, and a server 115. There are many examples of possible client computing systems 105. For example, the client computing system 105 may be a personal computer or a handheld mobile device. Further, the example network 100 may be configured to accommodate additional client computing systems 105 and/or servers 115.

In general, the client computing system 105 can include a variety of input/output devices, a central processing unit (CPU), a data storage device, and a network device. Typical input/output devices include keyboards, mice, displays, microphones, speakers, disk drives, CD-ROM drives, and flash drives. Computer readable media, such as the data storage device, provide for data retention. By way of example, computer readable media can include computer storage media and communication media. Computer storage media includes volatile and non-volatile memory implemented in any method or technology for storage of information such as computer readable instructions, data structures, program modules or other data. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

Among the plurality of information stored on the data storage device is a client operating system (OS) and applications. The client OS is a program that manages the hardware and software resources of the client computing system 105. Respective applications utilize the resources of the client computing system 105 to directly perform tasks specified by the user. For example, the client computing system 105 may include one or more software applications, such as a word processing or data processing program, that are used to create and edit document files. One example of such an application is the Microsoft Word word processing software application from Microsoft Corporation of Redmond, Wash. Other configurations for the client OS are possible as well.

The communication medium 110 is a bi-directional data communication path established between the client computing system 105 and the server 115. In certain embodiments, the communication medium 110 can be any of a number of wireless or hardwired WAN, LAN, Internet, or other packet-based communication networks such that data can be shared among one or more client computing systems 105 and servers 115.

The server 115 is a computing system that interfaces with the client computing system 105 via the communication medium 110. In general, the transmission of data between the server 115 and the client computing system 105 may include communications data, media data, application data, or any other forms of data.

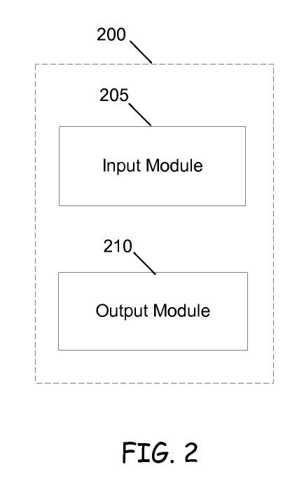

FIG. 2 is a block diagram of an example handheld mobile device 200. The mobile device 200 may embody the features of the client computing system 105 as depicted in the example network 100 of FIG. 1. In example embodiments, the mobile device 200 is a portable device such as a cellular telephone, a satellite telephone, a PDA, a smartphone, or other similar handheld device.

In general, the mobile device 200 includes an input module 205 and an output module 210. In the example embodiment, the handheld mobile device 200 is used to exchange wireless data between the server 115 and/or locally run one or more software applications. In one aspect, the one or more respective software applications may be used to view, edit, and/or author an application specific document, as described further below.

Referring still to FIG. 2, the input module 205 may be any device or method which permits the user to input information into the handheld mobile device 200. A standard QWERTY keypad is an example of an input module 205. The standard keypad enables the user to enter any alphanumeric character, symbol or other representative data into handheld mobile device 200. In one aspect, the input module 205 may additionally include one or more programmable “hotkeys.” In general, a “hotkey” provides easy access to an application or function that may under normal circumstances require time and effort to access. In other embodiments, the input module 205 can include one or more buttons, a touch screen, a pressure sensitive D-pad, voice recognition, and the like.

In the example embodiment, the output module 210 can be any device incorporated into the mobile device 200 that can communicate information to the user. In this respect, it will be appreciated that there are many methods to present or display information to a user. For example, the output module 210 may present visual information to the user via a liquid crystal display device (LCD) or a touch screen. In other embodiments, the output module 210 may additionally communicate information via non-visual methods such as audio or vibratory energy, or any combination thereof. For example, a microphone and/or a vibratory module may be used to communicate non-visual information to the user. In one embodiment of the mobile device 200, one or more output modules 210 may be configured to communicate information to the user accordingly.

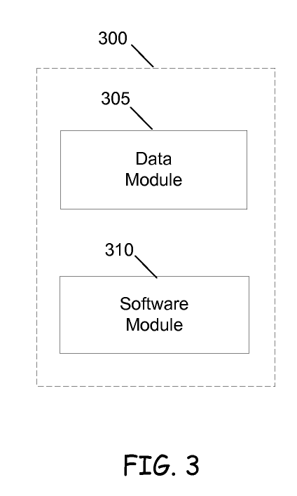

Referring now to FIG. 3, example functional modules 300 of the mobile device 200 of FIG. 2 are shown. In general, the functional modules 300 enable the user to access various functionalities and applications on the mobile device 200. In the example embodiment, the functional modules 300 include a data module 305 and a software module 310.

In one aspect, the data module 305 is configured to allow the handheld mobile device user to access communications and entertainment related features of the handheld mobile device 200. For example, the data module 305 may enable the user to make telephone calls, check voice mail, and access peer-to-peer messaging technologies such as text messaging and instant messaging. The data module 305 may additionally allow the user to use a web browser to access Internet web sites and various media data such as music, video and/or photos.

The software module 310 is configured to allow the handheld mobile device user access to one or more software applications. For example, the software module 310 may include one or more applications common to a suite of software used to view, author, and/or edit a document, such as a word processing document, an information document, and/or a spreadsheet document. In one embodiment, the software module 310 can be one or more of the applications associated with the Microsoft Office Mobile software suite, including the Microsoft Word word processing program, the EXCEL® spreadsheet program, and the POWERPOINT® presentation graphics program, as provided by Microsoft Corporation of Redmond, Wash. However, other software suites and/or applications can be used.

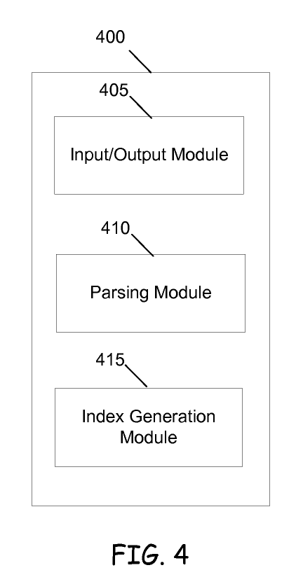

As shown in FIG. 4, in one embodiment, the software module 310 includes a spreadsheet module 400 having one or more functional capabilities. In the example embodiment, the spreadsheet module 400 enables a user to create, modify, and/or access spreadsheets. The spreadsheet module includes an input/output module 405, a parsing module 410, and an index generation module 415.

The input/output module 405 allows the user to access spreadsheet documents. For example, the input/output module 405 is programmed to load spreadsheet documents that are stored on computer readable storage media of the mobile device 200. The input/output module 405 is also programmed to store modified versions of the spreadsheet documents to the media.

The parsing module 410 is programmed to parse the spreadsheet document to identify certain attributes associated with the spreadsheet document. In some examples, the parsing module 410 parses the spreadsheet document as the spreadsheet document is opened by the input/output module 405. In other examples, the parsing module 410 can parse the spreadsheet document independently from the input/output module 405.

In general, documents created with respective applications associated with software module 310 can be stored in a format, such as the Extensible Markup Language (XML) format. In example embodiments, the parsing module 410 parses the XML spreadsheet document to look for certain data structures, as described below, such as sheets, tables, graphs, etc. When the parsing module 410 identifies a certain data structure, the parsing module 410 provides this information to the index generation module 415.

For example, in one embodiment, the parsing module 410 parses the XML-based document to identify certain XML-based tags that represent specific structures in the spreadsheet document. Examples of such tags include those that define a workbook name, a sheet name, and a chart name, as shown below:

<workbook name=“Workbook A” sheetId=“1” r:id=“rId1”/>

<sheet name=“Facts” sheetId=“1” r:id=“rId1”/>

<chart title=“Chart 1” chartId=“1” r:id=“rId1”/>

The parsing module 410 can be programmed to look for other types of data structures as well. Such examples include:

<table xmlns=“http://schemas.openxmlformats.org/path” id=“1” name=“Table1” displayName=“Table1” ref=“Range” totalsRowShown=“0”>

<definedName name=“definedName1”>‘Facts’! “Range”/>

In alternative embodiments, other file types besides XML-based file types can be used. In general, parsing module 410 can be programmed to parse a data file of any format and data type. For example, a binary-type file type can be used to store a document, and the parsing module 410 can be programmed to parse the binary file to identify relevant data structures. In other embodiments, other types of documents, such as word processing or presentation documents, can also be parsed, and document indexes can be generated, as described below.

The index generation module 415 is programmed to create a document index based on the identified data structures from the parsing module 410. As described further herein, the document index can be formed in a hierarchy to provide entries related to each of the data structures identified by the parsing module 410. The document index can, in turn, be used as a shortcut method for navigating the document.

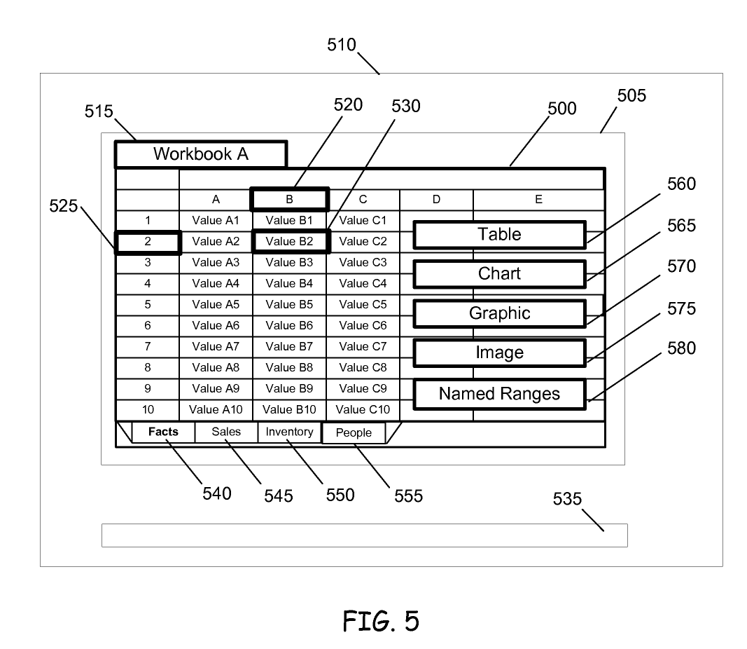

Referring now to FIG. 5, a spreadsheet workbook 500, as visualized on an output module 505 of a personal computer (PC) 510, is shown. In one embodiment, the spreadsheet workbook 500 may be assigned a unique name identifier by the user, (e.g., such as an identifier 515 like “Workbook A”), designating the specific instance of the spreadsheet workbook 500.

In general, the spreadsheet document 500 is a spreadsheet program application user interface that provides an organizational framework to enable the user to enter, organize and/or modify data. In the example embodiment, the most basic organizational structure of the spreadsheet document 500 is a cell, wherewith a data value may be entered and stored for further processing, as described further below. A respective instance of the spreadsheet document 500 can contain a plurality of cells, typically limited by the allocation of memory (e.g. volatile and non-volatile memory) assigned to the spreadsheet document. The cells of the spreadsheet document 500 are generally identified by column (such as represented by letters of the alphabet) and by row (such as represented by a number). For example, as depicted in FIG. 5, the cell located within the column labeled “B” 520 and within the row labeled “2” 525 is referred to as cell “B2” 530. In general, the user may navigate through the cells of the spreadsheet document 500 via the input module 535.

In one embodiment, a respective cell may be assigned a data value by the user. In general, the data value of a cell may be a specific data type, such as an alphanumeric character or a string. Additionally, the data value can be a result of a calculation based upon a formula that in certain embodiments can refer to data values assigned to one or more other cells. In one aspect, the data type or formula associated with a respective cell can have a unique identifier such that attributes associated with the cell may be discoverable.

In the example embodiment, in addition to the cell, the spreadsheet document 500 can contain additional organizational structures. For example, one or more worksheets may be defined. In general, worksheets are discemable organizational structures enabling a user the flexibility to organize data as desired. In the example embodiment, worksheets 540, 545, 550, 555 are shown including labels describing the content of the worksheets, such as “Facts,” “Sales,” “Inventory,” and “People” are depicted. In one aspect, the worksheets 540, 545, 550 and 555 can have a unique identifier such that the respective worksheets and attributes associated with the each respective worksheet may be discoverable.

Still referring to FIG. 5, in addition to a data value stored in one or more cells, the spreadsheet document 500 can contain one or more embedded data structures. In a similar manner to the data value stored in a given cell, a respective embedded data structure can have a unique identifier such that attributes associated with the data structure may be discoverable, as described in further detail below.

In one example embodiment, the spreadsheet document 500 contains embedded data structures 560, 565, 570, 575, 580. The respective embedded structures can be shown including labels, such as “Table”, “Chart”, “Graphic”, “Image”, and “Named Ranges.”

In general, the user can view, create, and edit respective embedded data structures, 560, 565, 570, 575, and 580 via the input module 535. For example, in one embodiment the table data structure 560 can be created and embedded in the spreadsheet document 500. In general, the table data structure 560 can be utilized to optimize the management and analysis of group of related data values. In one aspect, the table data structure 560 can be created by selecting a range of cells containing related data values, the data values can then be sorted, filtered, formatted. In the example spreadsheet document 500 as shown in FIG. 5, three columns (A-C) and ten rows (1-10) can represent a collection of cells containing related data values. In this manner, cells “A1:A10,” “B1:B10,” and “C1:C10” may be selected to create embedded data structure 560. In one aspect, the table data structure 560 can have a unique identifier such that the table data structure 560 and attributes associated with the table data structure 560 can be discoverable.

Additionally, in one embodiment the chart data structure 560 can be created and embedded in the spreadsheet document 500. In general, the chart data structure 560 is a graphical interpretation of a group or groups of data values. For example, the chart data structure 560 can be a pie chart, a bar chart, column chart, a scatter chart, etc. The respective data values can be selected as desired from cells located in one or more worksheets of the spreadsheet document 500. In one aspect, the chart data structure 560 can have a unique identifier such that the chart data structure 560 and attributes associated with the chart data structure 560 can be discoverable.

Additionally, in one embodiment the graphic data structure 570 can be created and embedded in the spreadsheet document 500. In one example the graphic data structure 570 can be created using, for example, SMARTART™ graphics technology from Microsoft Corporation. In general, the graphic data structure 570 is a graphical representation of information. For example, the graphic data structure 570 can be a list, where in general, the form of the list if configurable such that content and arrangement of the list can be intelligently grouped and connected. There are many other forms the graphic data structure 570 may embody to optimally configure content. For example, the graphic data structure 570 can be configured to possess a variety of general forms such as a Process, a Type, and a Hierarchy, etc. In one aspect, data structure 570 can have a unique identifier such that the graphic data structure 570 and attributes associated with the graphic data structure 570 can be discoverable.

Additionally, in one embodiment the image data structure 575 can be created and embedded in the spreadsheet document 500. In general, the image data structure 575 is a digital representation of a picture that may be formatted accordingly to typical image formats such as “.jpg”, “.tiff”, “.bmp”, “.gif”, and the like. In one example, the image data structure 575 may be embedded in a spreadsheet document 500 via a hyperlink or a “drag and drop” process. In one aspect, the image data structure 575 can have a unique identifier such that the image data structure 575 and attributes associated with the image data structure 575 can be discoverable.

Additionally, in one embodiment the Named Ranges data structure 580 can be created and embedded in the spreadsheet document 500. In general, the Named Ranges data structure 580 enables a user to assign a meaningful and descriptive name to a single cell, a range of cells, or a group of cells to optimize user interpretation of data stored in the spreadsheet document 500 if the organizational structure of the data is complex. For example, the Named Ranges data structure 580 data as shown in FIG. 5 can be constructed from the range of cells A1:A10. In this manner, the range of cells A1:A10 can be assigned a name such as “Projected Sales”. In one aspect, the Named Ranges data structure 580 data type can have a unique identifier such that the Named Ranges data structure 580 data type and attributes associated with the Named Ranges data structure 580 data type can be discoverable.

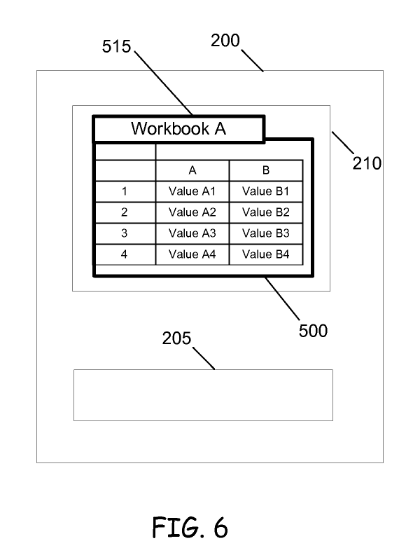

Referring now to FIG. 6, the spreadsheet workbook 500 of FIG. 5 is shown as visualized on the output module 605 of the handheld device 200. FIG. 6 illustrates an issue regarding limited screen space as provided by the output module 210 of the mobile handheld device 200, in contrast to visualization of spreadsheet workbook 500 on the PC output module shown in FIG. 5. Typically, an output module of a common PC is approximately 10× the size of an output module of a common mobile handheld device. In this manner, viewing documents designed for PC viewing is not conducive to viewing the same respective documents on a mobile handheld device.

Consequently, as depicted in FIG. 6, only a relatively small portion of the spreadsheet workbook 500 can be legibly displayed on the mobile handheld device 200. As a result, a mobile handheld device user is required to navigate through the information looking for specific content which can be time consuming. Accordingly, a document index according to the present disclosure can be utilized to provide the user a consolidated navigable interface to allow the user to quickly identify content in the document and access the desired information in fast manner.

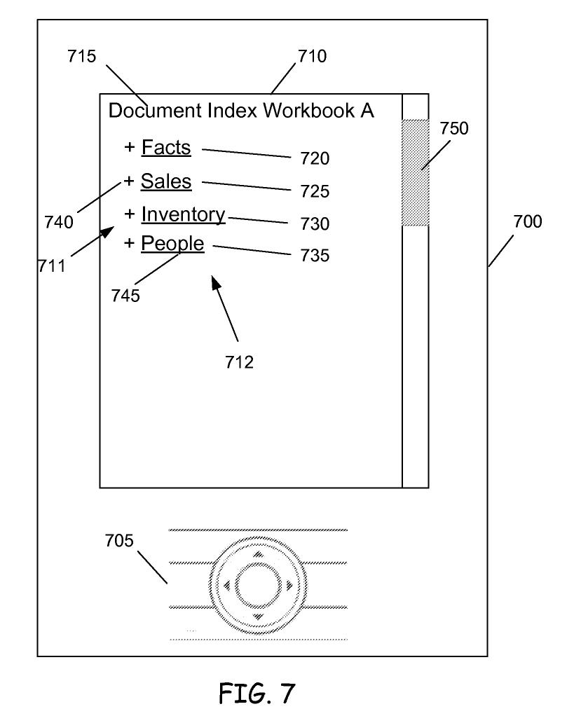

Referring now generally to FIGS. 7-10, an example document index for document navigation on an example handheld mobile device is shown. In general, the example document index and the example handheld mobile device is described in detail with reference to the embodiments of the present disclosure as described in conjunction with FIGS. 1 through 6.

FIG. 7 is an example handheld mobile device 700 having features in accordance with the present disclosure. The handheld mobile device 700 includes a pressure sensitive D-pad input module 705 and a touch screen input/output module 710.

In general, presented to the user on the output module 710 is a document index 712 generated from the spreadsheet 500. In one embodiment, the spreadsheet 500, formatted as an XML-based document, is passed through a parsing algorithm that identifies and organizes discoverable attributes associated with the spreadsheet 500. In general, the parsing algorithm traverses the XML document and identifies one or more “tags” having identifiable attributes. The identifiable attributes are then assembled to construct a hierarchal tree-like structural representation of the spreadsheet 500 that can be presented to the user via the output module 710 in the form of a navigable document index 712 having a plurality of entries 711 corresponding to the identified attributes in the spreadsheet document. The user can navigate through the document index 712, selecting an entry as desired via the input module 705. When particular content in the document index 712, such as one of the entries 711, is selected, the actual selected content of the spreadsheet 500 is presented to the user.

In the example embodiment, an expansion symbol 740 indicates whether or not the hierarchal tree-like structure can be expanded further to display respective discoverable attributes located within the respective worksheet entries 720, 725, 730 and 735. In one aspect, a “+” sign indicates that there are discoverable attributes available. In a second aspect, a “−” indicates that there are no further discoverable attributes available. Additionally, an underscore 745 can indicates that the respective worksheet entries 720, 725, 730, 735 are linked to a specific location in the example spreadsheet 500. The output module 710 additionally includes a scroll bar 750 to enable a user to vertically navigate the document index 712.

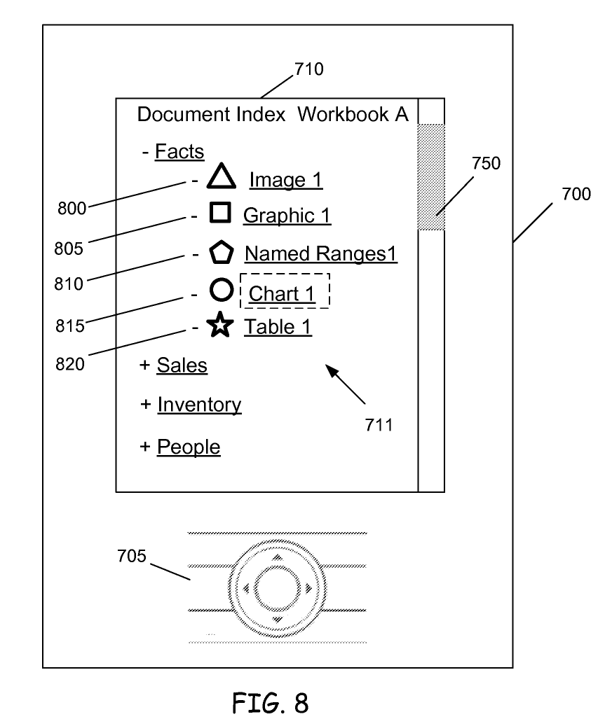

Referring now to FIG. 8, an expanded section of the entry 720 of the example document index 712 is shown. In general, the input module 705 may be manipulated to select the worksheet entry 720, thereby expanding the hierarchal tree-like structure to display discoverable attributes located beneath the worksheet entry 720. In the example embodiment, embedded data structure entries 800, 805, 810, 815, 820 are identified as having discoverable attributes. Additionally, the names of the respective embedded data structures are discoverable attributes, as shown “Image1,” “Graphic1,” “NamedRanges1,” “Chart1,” and “Table1.”

In one aspect, embedded structure entries 800, 805, 810, 815, and 820 each have a unique graphical identifier that can be displayed to notify the user the data type of embedded data. For example, entry 800 is an image data type and may be represented by a triangle, entry 805 is a graphic data type and may be represented by a box, entry 810 is ranges data type and may be represented by a pentagon, entry 815 is a chart data type and may be represented by a circle, and entry 820 is a table data type and may be represented by a star. Other configurations are possible. For example, in another embodiment, colors or text can be used to identify different data types.

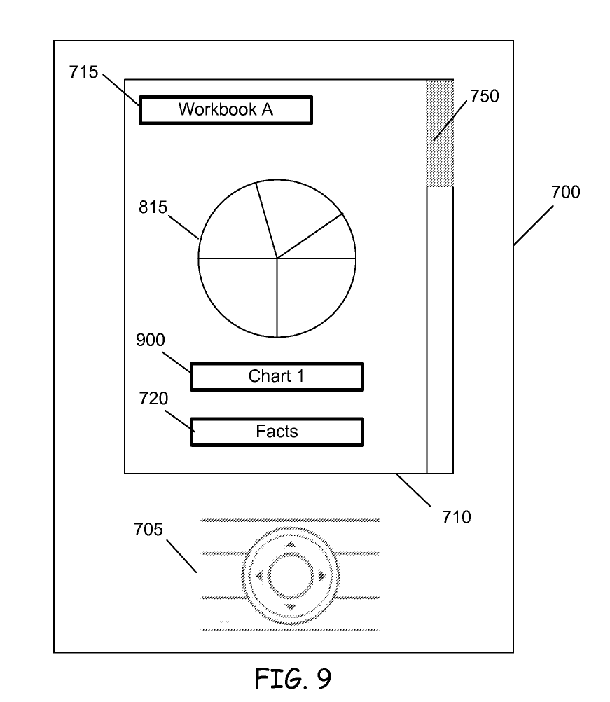

As shown in FIG. 9, when a user selects one of the embedded structure entries 800, 805, 810, 815, 820, the display is thereupon updated to show the selected structure. For example, if the user selects embedded structure entry 815, the display is updated to show the portion of the spreadsheet including the embedded structure (i.e., a chart in the example shown). The user can thereupon select a menu item or press a hotkey to access the document index again to select a different structure of the spreadsheet.

In one embodiment, the document index is generated and displayed automatically when the user opens a spreadsheet document. The user can then select an entry from the document index to quickly access that structure, or can simply close the document index to view the entire spreadsheet document. The user can access the document index at a later point by selecting the appropriate menu item or hotkey. Other configurations are possible.

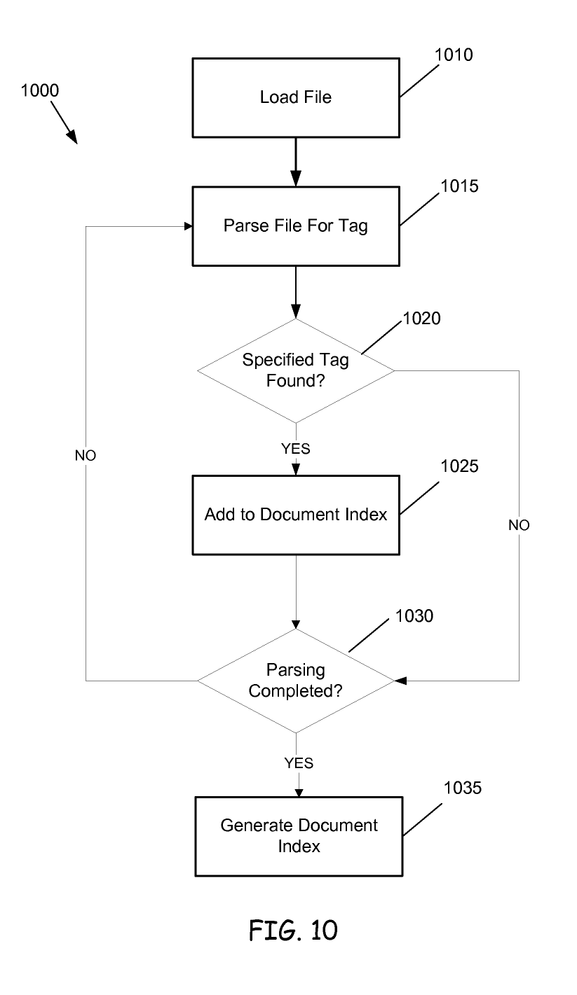

Referring now to FIG. 10, an example method 1000 is shown for generating a document index on a handheld mobile device.

The method 1000 begins at operation 1010, whereat a document is loaded into memory. For example, as described above, the user can choose to open a document, such as a spreadsheet document. Once selected, the spreadsheet document is loaded into memory.

Next, at operation 1015, the file is parsed to identify specific tags that are associated with data structures, as noted above. In some embodiments, the parsing can be completed at the time the file is loaded into memory, or at a later point. Control is then passed to operation 1020; a determination is made during parsing if a specific tag is found. If a specific tag is not found, control is instead passed to operation 1030 described below. Alternatively, if a specific tag is found, control is passed to operation 1025, and information about the tag (e.g., type, name, and location in spreadsheet file) is added to the document index.

At operation 1030, a determination is made as to whether or not parsing of the file is complete. If not, control is passed back to operation 1015 and parsing continues. If so, control is instead passed to operation 1035 and the document index is generated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile device, comprising:
a display;
a computer readable storage medium storing a document file; and
an application stored on the computer readable storage medium, the application being programmed to include:
an input/output module programmed to load a document and render the document on the display;
a parsing module programmed to parse the document and to identify certain tags within the document that are associated with data structures; and
an index generation module programmed to create a document index based on the certain tags identified by the parsing module, the document index being formed in a hierarchy.

2. The device of claim 1, wherein the parsing module is programmed to identify certain extensible markup language tags associated with specific data structures in the document.

3. The device of claim 2, wherein the document is a spreadsheet document.

4. The device of claim 3, wherein the certain extensible markup language tags include tags associated with workbook names, sheet names, and charts.

5. The device of claim 2, wherein the index generation module is programmed to automatically generate the document index when the document is opened.

6. The device of claim 5, wherein the document index is displayed on the display.

7. The device of claim 6, wherein, upon selection of an entry on the document index, the application is programmed to display a location in the document where a specific data structure corresponding to the entry is located.

8. The device of claim 6, wherein the index generation module is programmed to form the document index into a tree-like hierarchy of a plurality of entries, with each of the entries being linked to one of the specific data structures.

9. The device of claim 1, wherein the index generation module is programmed to automatically generate the document index when the document is opened.

10. The device of claim 1, wherein the document index is displayed on the display.

11. The device of claim 1, wherein, upon selection of an entry on the document index, the application is programmed to display a location in the document where a specific data structure corresponding to the entry is located.

12. The device of claim 1, wherein the index generation module is programmed to form the document index into a tree-like hierarchy of a plurality of entries, with each of the entries being linked to one of the specific data structures.

13. A mobile device, comprising:
a display;
a computer readable storage medium storing a spreadsheet document;
a spreadsheet application stored on the computer readable storage medium, the spreadsheet application being programmed to include:
an input/output module programmed to load the spreadsheet document and render the spreadsheet document on the display, the spreadsheet document being stored in an extensible markup language format;
a parsing module programmed to parse the spreadsheet document and to identify certain extensible markup language tags within the document that are associated with data structures of the spreadsheet document, the data structures including a workbook name, a spreadsheet name, and a chart name; and
an index generation module programmed to create a document index based on the certain extensible markup language tags identified by the parsing module corresponding to the data structures, the document index being formed in a tree-like hierarchy including a plurality of entries, each of the entries including a summary of one of the data structures and being linked to the data structure;
wherein the document index is automatically generated when the spreadsheet document is opened; and
wherein, when a user selects a specific entry in the document index, the spreadsheet application is further programmed to display a data structure of the spreadsheet document associated with the specific entry on the display.

14. The device of claim 1, wherein the spreadsheet application is programmed to automatically display the document index when the document is opened.

15. A method for creating a document index, the method comprising:
opening a spreadsheet document;
parsing the spreadsheet document to identify tags associated with specific data structures of the spreadsheet document;
identifying certain extensible markup language tags identified during parsing, the tags corresponding to the data structures; and
creating the document index based on the identified tags, the document index being formed in a tree-like hierarchy including a plurality of entries, each of the entries including a summary of one of the data structures and being linked to the data structure.

16. The method of claim 15, further comprising selecting the tags from the group consisting of workbook name, sheet name, and chart name.

17. The method of claim 15, further comprising displaying the document index.

18. The method of claim 17, further comprising displaying the document index when the spreadsheet document is opened.

19. The method of claim 17, further comprising automatically displaying the document index when the spreadsheet document is opened.

20. The method of claim 15, further comprising displaying a data structure associated with an entry of the document index when the user selects the entry.
